(19) United States
(12) Patent Application Publication
(10) Pub. No.: US 2015/0077351 A1
(43) Pub. Date: Mar. 19, 2015

(54) METHOD AND SYSTEM FOR DETECTING TOUCH ON USER TERMINAL

(71) Applicant: HYUNDAI MOTOR COMPANY, Seoul (KR)

(72) Inventor: Jong Bok LEE, Suwon-si (KR)

(73) Assignee: HYUNDAI MOTOR COMPANY, Seoul (KR)

(21) Appl. No.: 14/098,371

(22) Filed: Dec. 5, 2013

(30) Foreign Application Priority Data
Sep. 13, 2013 (KR) 10-2013-0110670

(51) Int. Cl. G06F 3/041

(52) U.S. Cl. CPC G06F 3/0416
USPC 345/173

(57) ABSTRACT

A touch detecting method and system on a user terminal having a touch screen includes detecting an object which approaches the touch screen of the user terminal. It is determined whether touch of the object, which approaches the touch screen, is an intended touch. When it is determined that the touch of the object is the intended touch, a touched position is determined based on a sound generated when the object touches the touch screen. Touch information is provided to perform a function corresponding to the touched position determined based on the sound.

### CROSS-REFERENCE TO RELATED APPLICATION

This application claims the benefit of priority to Korean Patent Application No. 10-2013-0110670 filed in the Korean Intellectual Property Office on Sep. 13, 2013, the entire contents of which are incorporated herein by reference.

### TECHNICAL FIELD

The present disclosure relates to a method and a system for detecting a touch on a user terminal including a touch screen, and more particularly, to a method and a system for detecting a touch on a user terminal, which determine a user's intention of the touch using an ultrasonic wave sensor and recognize a sound caused by the touch of the user or a sound generated by fingers using a sound scanner to recognize a touch gesture of the user.

### BACKGROUND

As well known in the art, a touch screen is a screen which may directly receive an input from the screen. When a human hand or an object is in contact with a letter displayed on the screen or a specific position without using a keyboard, the position is recognized so as to perform a specific software processing. The touch screen is widely used as an input screen of a user terminal, such as a portable phone or a computer.

The touch screen is generally classified into a pressure sensitive type and an electrostatic type (electrostatic capacitive type). The pressure sensitive type touch screen detects a pressure change on the touch screen, and an input device for the pressure sensitive type touch screen is not limited.

The electrostatic capacitive type touch screen detects the touch using a micro current which flows into a body. It allows multi-touch and has a fast reaction time. However, the electrostatic capacitive type touch screen cannot distinguish a touched pressure (strength), so that only on-off touch control is available.

The touch screen mounted in a vehicle is generally a curved touch screen, as illustrated in FIG. 1, and uses an infrared camera 14 which has an infrared illumination in order to recognize a hand gesture of a user when touching.

A user terminal 10 having the curved touch screen illustrated in FIG. 1 includes a touch screen 12, an infrared camera 14, a projector 16 which outputs an image and/or graphic information, an aspheric reflection mirror 11, and a reflection mirror 13. The above configuration is obvious to a person of ordinary skill in the art so that detailed description thereof will be omitted.

In the case of the touch screen which uses the infrared camera to detect the touch, the infrared camera is sensitive to external light interference, thus causing various problems.

In order to solve the problems, Korean Unexamined Patent Application Publication No. 10-2013-0048578 discloses a technology in which a touch is recognized only when an intensity of an ultrasonic wave signal is changed so as not to be influenced by an external environment. Korean Patent No. 10-0856919 discloses a technology which detects a sound generated when a gesture is drawn on a touch pad, analyzes the detected sound to extract feature data, and recognizes an effective gesture in accordance with the extracted feature data.

According to the prior arts, a sound or an ultrasonic wave is used to recognize an effective touch to solve problems caused by an external light interference. However, when a user unintentionally touches a screen, the unintentional touch may not be distinguished. Therefore, a technology to precisely understand intention of the user for his or her touch is necessary when a user's hand approaches the touch screen.

The above information disclosed in this Background section is only for enhancement of understanding of the background of the disclosure, and therefore, it may contain information that does not form the prior art that is already known in this country to a person of ordinary skill in the art.

### SUMMARY

The present disclosure provides a method and system for detecting a touch on a user terminal which determines a user's intention of the touch using an ultrasonic wave sensor and recognizes a sound caused by the touch of the user or a sound generated by fingers (for example, “tick” or “tock”) using a sound scanner to recognize a touch gesture of the user, thus reducing a cost and preventing from an external light interference.

According to an exemplary embodiment of the present disclosure, a touch detecting method on a user terminal having a touch screen includes detecting an object which approaches the touch screen of the user terminal. It is determined whether touch of the object, which approaches the touch screen, is an intended touch. When it is determined that the touch of the object (for example, a finger or a touch stick) is the intended touch, a touched position is determined based on a sound (for example, “tick” or “tock”) generated when the object touches the touch screen. Touch information is provided to perform a function corresponding to the touched position determined based on the sound.

The method may further include determining whether the generated sound when the touch screen is touched is generated by a normal touch.

According to another exemplary embodiment of the present disclosure, a touch detecting system on a user terminal having a touch screen includes an ultrasonic wave sensor detecting an object which approaches the touch screen of the user terminal. A sound detecting sensor array detects a sound generated when the touch screen is touched. A sound scanner scans the sound detected by the sound detecting sensor array. A touch detecting controller determines whether touch of the object, which approaches the touch screen (for example, a finger or a touch stick), is an intended touch, and if the touch of the object is the intended touch, a touched position is determined based on the sound generated when the object touches the touch screen to provide information on the touched position so as to perform a function corresponding to the touch.

The touch detecting controller may include an ultrasonic wave signal transmitter/receiver which transmits and receives an ultrasonic wave signal of the ultrasonic wave sensor and a touched position determiner which determines the touched position based on the sound scanned by the sound scanner.

The touch detecting controller may further include a noise eliminating filter which filters only the sound (for example, “tick” or “tock”) generated by a normal touch from the sound detected by the sound detecting sensor array.

The touch screen, which is used for the user terminal, may be a curved touch screen for a vehicle.

As described above, according to an exemplary embodiment of the present disclosure, a user's intention of the touch is determined using an ultrasonic wave sensor, and a sound caused by the touch of the user or a sound generated by fingers is recognized using a sound scanner to recognize a touch gesture of the user, thus reducing a cost and preventing from an external light interference.

### BRIEF DESCRIPTION OF THE DRAWINGS

FIG. 1 is a conceptual view illustrating a touch screen device which uses an infrared camera according to the related art.

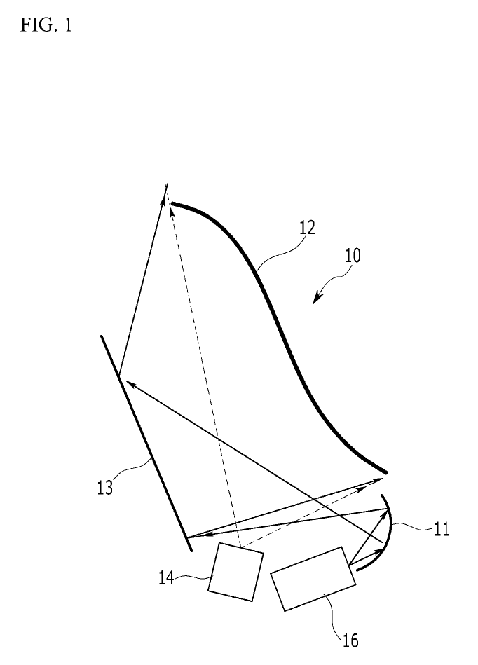

FIG. 2 is a schematic view illustrating a touch detecting system of a user terminal according to an exemplary embodiment of the present disclosure.

FIG. 3 is a detailed schematic view of a touch detecting controller according to an exemplary embodiment of the present disclosure.

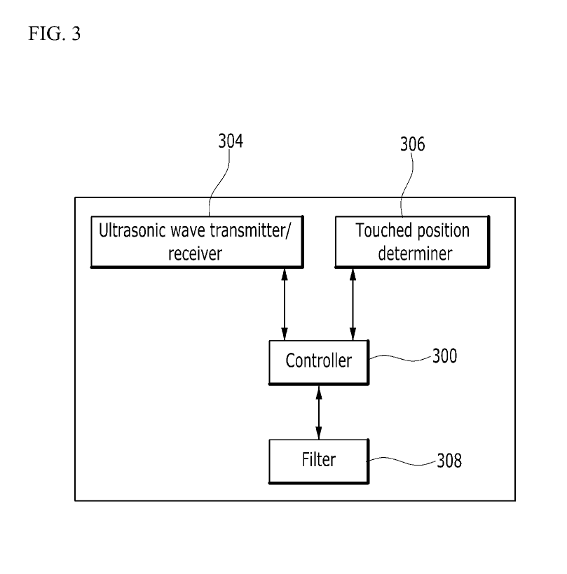

FIG. 4 is a schematic diagram of a sound detecting sensor array according to an exemplary embodiment of the present disclosure.

FIG. 5 is a flowchart of a touch detecting method of a user terminal according to an exemplary embodiment of the present disclosure.

### DETAILED DESCRIPTION OF THE EMBODIMENTS

In the following detailed description, only certain exemplary embodiments of the present disclosure have been shown and described simply by way of illustration. As those skilled in the art would realize, the described embodiments may be modified in various different ways, all without departing from the spirit or scope of the present disclosure.

In the specification, unless explicitly described to the contrary, the word “comprise” and variations such as “comprises” or “comprising” will be understood to imply the inclusion of stated elements but not the exclusion of any other elements. Like reference numerals designate like elements throughout the specification.

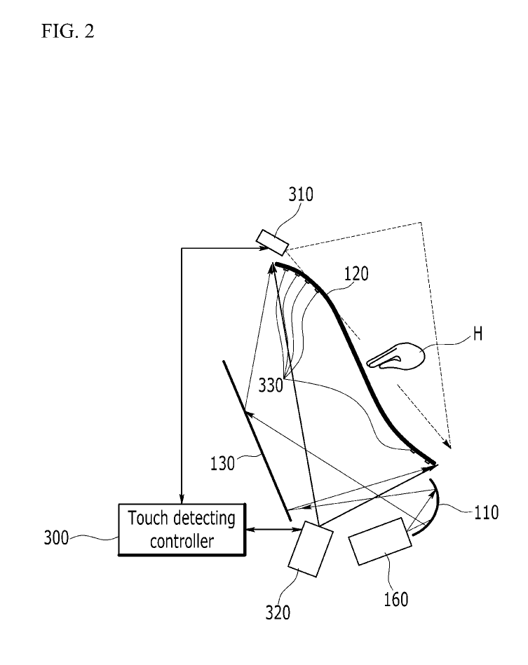

FIG. 2 is a schematic view illustrating a touch detecting system of a user terminal according to an exemplary embodiment of the present disclosure.

A touch detecting system of a user terminal according to an exemplary embodiment of the present disclosure is a system which determines a touched position using a touched sound.

Such a touch detecting system of a user terminal according to an exemplary embodiment of the present disclosure includes an ultrasonic wave sensor 310 which detects an object (for example, a finger) which approaches a touch screen 120 of the user terminal, a sound detecting sensor array 330 which detects a sound (for example, “tick” or “tock”) generated when the touch screen 120 is touched, and a sound scanner 320 which scans the sound detected by the sound detecting sensor array 330. A touch detecting controller 300 determines whether touch the object, which approaches the touch screen 120, is an intended touch. If the touch of object which approaches the touch screen 120 is an object (for example, a finger or a touch stick) H having the intended touch, a touched position is determined based on the sound generated when the object touches the touch screen 120 to provide information on the touched position so as to perform a function corresponding to the touch.

The ultrasonic wave sensor 310 detects the object in a touch range of the touch screen 120. The ultrasonic wave sensor 310 may use an ultrasonic wave sensor that has been used in the related art.

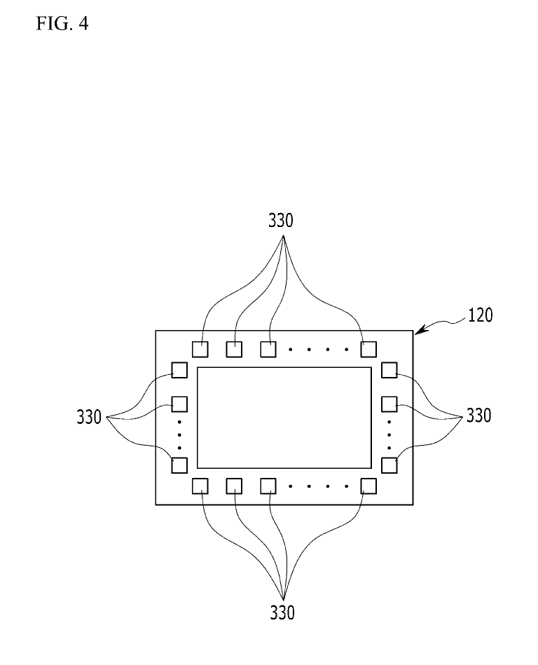

The sound detecting sensor array 330 may be configured, as illustrated in FIG. 4, such that a plurality of sound detecting sensors are arranged with a predetermined distance and at predetermined intervals. However, it should be understood that the scope of the present disclosure is not limited thereto. Even though the sound detecting sensor array 330 has a different configuration, if the configuration may substantially detect the sound generated when the touch screen is touched, a technical spirit of the present disclosure may be applied thereto.

The sound scanner 320 is configured to scan the sound which is detected by the sound detecting sensor array 330 and input the scanned sound to the touch detecting controller 300, so that a sound scanner 320 according to the related art may be used therefor.

The touch detecting controller 300 is at least one microprocessor executed by a predetermined program and/or hardware that includes the microprocessor. The predetermined program may include a series of commands to perform a touch detecting method of a user terminal according to an exemplary embodiment of the present disclosure, which will be described below.

The touch detecting controller 300 may include an ultrasonic wave signal transmitter/receiver 304 which transmits and receives an ultrasonic wave signal of the ultrasonic wave sensor 310. A touched position determiner 306 determines a touched position based on a sound scanned by the sound scanner 320, and a noise eliminating filter 308 filters only a sound (for example, “tick” or “tock”) generated by a normal touch from the sound detected by the sound detecting sensor array 330.

A user terminal, to which a touch detecting system of a user terminal according to an exemplary embodiment of the present disclosure is applied, may be a user terminal used for a vehicle, such as a curved touch screen.

Such a user terminal may include, as illustrated in FIG. 2, a touch screen 120, a projector 160 which outputs an image and/or graphic information, an aspheric reflection mirror 110, a reflection mirror 130, and constituent elements which are obvious to a person of ordinary skill in the art, and thus, the detailed description thereof will be omitted.

Hereinafter, a touch detecting method of a user terminal according to an exemplary embodiment of the present disclosure will be described in detail with reference to accompanying drawings.

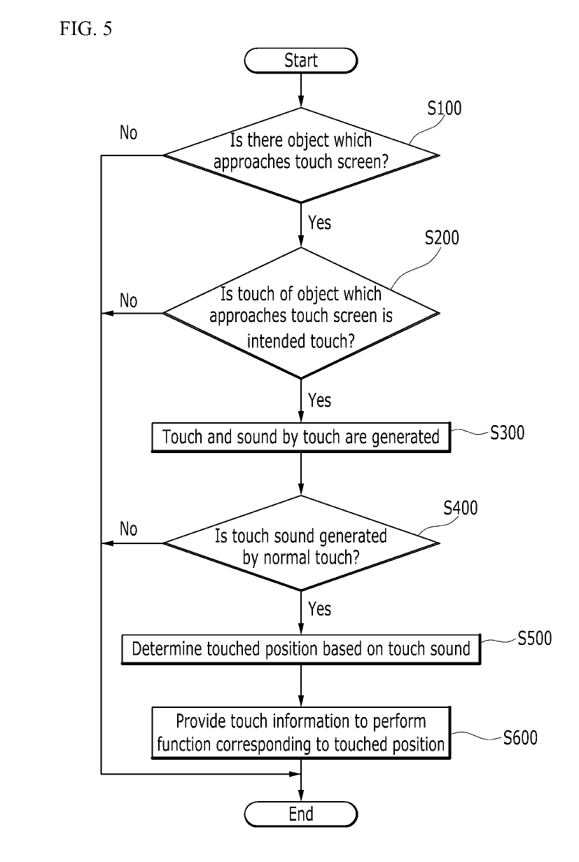

FIG. 5 is a flowchart of a touch detecting method of a user terminal according to an exemplary embodiment of the present disclosure.

As illustrated in FIG. 5, when the user terminal is being used, the touch detecting controller 300 controls the ultrasonic wave sensor 310 to detect whether there is an object which approaches the touch screen 120 of the user terminal in step S100. When there is the object which approaches the touch screen 120, the touch detecting controller 300 determines whether the object which approaches the touch screen 120 has a touch intention in step S200.

The object which has the intended touch may be, for example, a finger or a touch stick.

Alternatively, the touch detecting controller 300 determines a movement speed, a size, and a shape of the object based on a signal received from the ultrasonic wave sensor 310 to determine whether the touch of the object which approaches the touch screen 120 is an intended touch. Such a technology is obvious to a person of ordinary skill in the art, and thus, the detailed description will be omitted.

When the touch of the object which approaches the touch screen 120 is an intended touch, that is, a finger H in step S200, the touch detecting controller 300 controls the sound scanner 320 to determine a touched position based on a sound generated when the finger H touches the touch screen 120 which is detected by the sound detecting sensor array 330 in step S300.

Among the sound detected by the sound detecting sensor array 330, a sound generated by an abnormal touch may be eliminated by the filter 308.

That is, the touch detecting controller 300 checks whether the sound in accordance with the touch of the touch screen 120 passes through the filter 308 to determine whether the touch of the touch screen 120 is the normal touch in step S400.

The sound scanner 320 scans the sound detecting sensor array 330 to output a signal for checking the touched position of the touch screen 120. The touch detecting controller 300 then determines the touched position based on the touched position signal output by the sound scanner 320 in step S500 and provides information on the determined touched position to a touch processor (not illustrated) of the user terminal to allow the touch processor of the user terminal to perform a function corresponding to the detected touched position in step S600.

The touch detecting method of a user terminal according to an exemplary embodiment of the present disclosure may determine the touch intention of the user using the ultrasonic wave sensor and recognize the sound in accordance with the touch of the user or the sound generated by the finger using the sound scanner to recognize a touch gesture of the user.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A touch detecting method on a user terminal having a touch screen, the method comprising:
detecting an object which approaches the touch screen of the user terminal;
determining whether touch of the object which approaches the touch screen is an intended touch;
when it is determined that the touch of the object which approaches the touch screen is the intended touch, determining a touched position based on a sound generated when the object touches the touch screen; and
providing touch information to perform a function corresponding to the touched position determined based on the sound.

2. The method of claim 1, further comprising determining whether the generated sound is generated by a normal touch when touching the touch screen.

3. A touch detecting system on a user terminal having a touch screen, the system comprising:
an ultrasonic wave sensor which detects an object that approaches the touch screen of the user terminal;
a sound detecting sensor array which detects a sound generated when the touch screen is touched;
a sound scanner which scans the sound detected by the sound detecting sensor array; and
a touch detecting controller which determines whether touch of the object is an intended touch, and if the touch of the object is the intended touch, determines a touched position based on the sound generated when the object touches the touch screen to provide information on the touched position so as to perform a function corresponding to the touch.

4. The system of claim 3, wherein the touch detecting controller includes:
an ultrasonic wave signal transmitter/receiver which transmits and receives an ultrasonic wave signal of the ultrasonic wave sensor; and
a touched position determiner which determines the touched position based on the sound scanned by the sound scanner.

5. The system of claim 4, wherein the touch detecting controller further includes a noise eliminating filter which filters only a sound generated by a normal touch from the sound detected by the sound detecting sensor array.

6. The system of claim 3, wherein the touch screen which is used for the user terminal is a curved touch screen which is applied to a vehicle.
